(19) United States
(12) Patent Application Publication
(10) Pub. No.: US 2015/0292550 A1
(43) Pub. Date: Oct. 15, 2015

(54) COMPOSITE AUTOMOTIVE CONNECTING ROD AND METHOD OF MANUFACTURE

(71) Applicant: Toyota Tsusho America, Inc., New York, NY (US)

(72) Inventor: Martin Streckel, Farmington Hills, MI (US)

(21) Appl. No.: 14/685,932

(22) Filed: Apr. 14, 2015

Related U.S. Application Data
(60) Provisional application No. 61/979,648, filed on Apr. 15, 2014.

(51) Int. Cl. F16C 7/02; B29C 70/56; B29C 70/48

(52) U.S. Cl. CPC F16C 7/026; F16C 7/023; B29C 70/48; B29C 70/56; B29K 2101/12

(57) ABSTRACT

Methods for connecting rods for automotive vehicles are provided. In particular, the disclosed methods produce connecting rods composed of composite material which includes organic polymeric plastic and carbon fiber. In some instances, the methods utilize reinforcing tape to improve strength. Connecting rods composed substantially of organic polymeric plastic and carbon fiber are also disclosed. In some instances, the connecting rods include reinforcing tape for increased strength.

### RELATED APPLICATIONS

This application claims benefit of U.S. Provisional Application No. 61/979648, filed on Apr. 15, 2014, which is herein incorporated by reference in its entirety.

### BACKGROUND

Replacement of dense metals with relatively lightweight polymeric components in the bodies of automotive, aircraft, and other vehicles has made such vehicles lighter, increasing fuel efficiency and performance. Substitution of metallic components with polymeric or composite components within an internal combustion engine presents unique challenges due to the combination of high temperature and formidable forces to which such components are routinely subjected. Development of engine components constructed of polymeric or composite materials that can reliably endure such forces and temperatures without failure is thus an important yet challenging step to continue current trends toward lighter, more efficient vehicles.

A connecting rod is a component of a reciprocating internal combustion engine that connects a piston to a crankshaft, and functions to transfer the reciprocating translational motion of the piston into rotational motion of the crankshaft. As such, a connecting rod in an engine is subjected to considerable heat, intense force, and continuous, multidirectional acceleration of large magnitude. In particular, due to the very large, multidirectional acceleration to which a connecting rod is continuously subject, the connecting rod, like other rapidly moving components, consumes engine output to an extent which belies its relatively small size. For this reason, replacement of metal with plastics and other lightweight components in connecting rods and other rapidly moving parts can be expected to particularly improve engine and vehicle efficiency.

### SUMMARY

Methods for fabricating composite connecting rods are provided. Also provided are connecting rods composed substantially of lightweight, composite materials while yet possessing functional tensile strength and endurance

In one aspect, a method for fabricating a composite connecting rod is disclosed. The method includes encircling displacement disks of a connecting rod mold with a reinforcing tape and injecting a molding-composite material into the connecting rod mold. The composite material comprises a mixture of organic polymer and reinforcing fiber.

In another aspect, a connecting rod is disclosed. The connecting rod is composed substantially of a moldable composite material. The moldable composite material includes organic polymer and reinforcing fiber.

### BRIEF DESCRIPTION OF THE DRAWINGS

Various aspects and advantages of the disclosure will become apparent and more readily appreciated from the following description of the embodiments taken in conjunction with the accompanying drawings, of which:

FIG. 1 describes an exemplary method for fabricating a connecting rod composed substantially of composite material;

FIG. 2 is a top plan view of an exemplary connecting rod mold that can be employed for fabricating the connecting rod;

FIG. 3 is a perspective view of the connecting rod mold of FIG. 2 with an exemplary band of reinforcing tape extending around a pair of displacement disks used to form apertures in the connecting rod;

FIG. 4 is a perspective view of the connecting rod mold of FIG. 2 with an exemplary band of reinforcing tape applied to an inner circumference of the mold;

FIG. 5 is a longitudinal cross-sectional view of a connecting rod mold including a movable displacement disk;

FIG. 6 is a longitudinal cross-sectional view of a connecting rod mold including an alternately configured movable displacement disk;

FIG. 7 is a longitudinal cross-sectional view of a connecting rod mold including yet another alternately configured movable displacement disk;

FIG. 8 is a plan view of an exemplary connecting rod composed substantially of composite material and including inner and outer reinforcing tapes;

FIG. 9 is a plan view of an alternately configured exemplary connecting rod composed substantially of composite material and including inner and outer reinforcing tapes; and

FIG. 10 is a graph of exemplary data from tensile strength tests of a connecting rod of the type illustrated in FIG. 8, fabricated with and without reinforcing tape.

### DETAILED DESCRIPTION

A method for fabricating a connecting rod, a connecting rod so fabricated, and a connecting rod composed of a composite material are disclosed. As explained in the following description, the method involves injection molding of a composite material. The composite material can include an organic polymer and reinforcing fiber. As used herein, the term “reinforcing fiber” describes a material that can comprise any or a combination of carbon fiber, aramid fiber, or carbon nanotubes. Also disclosed is a mold for forming a composite connecting rod, the mold having a movable/removable displacement disk.

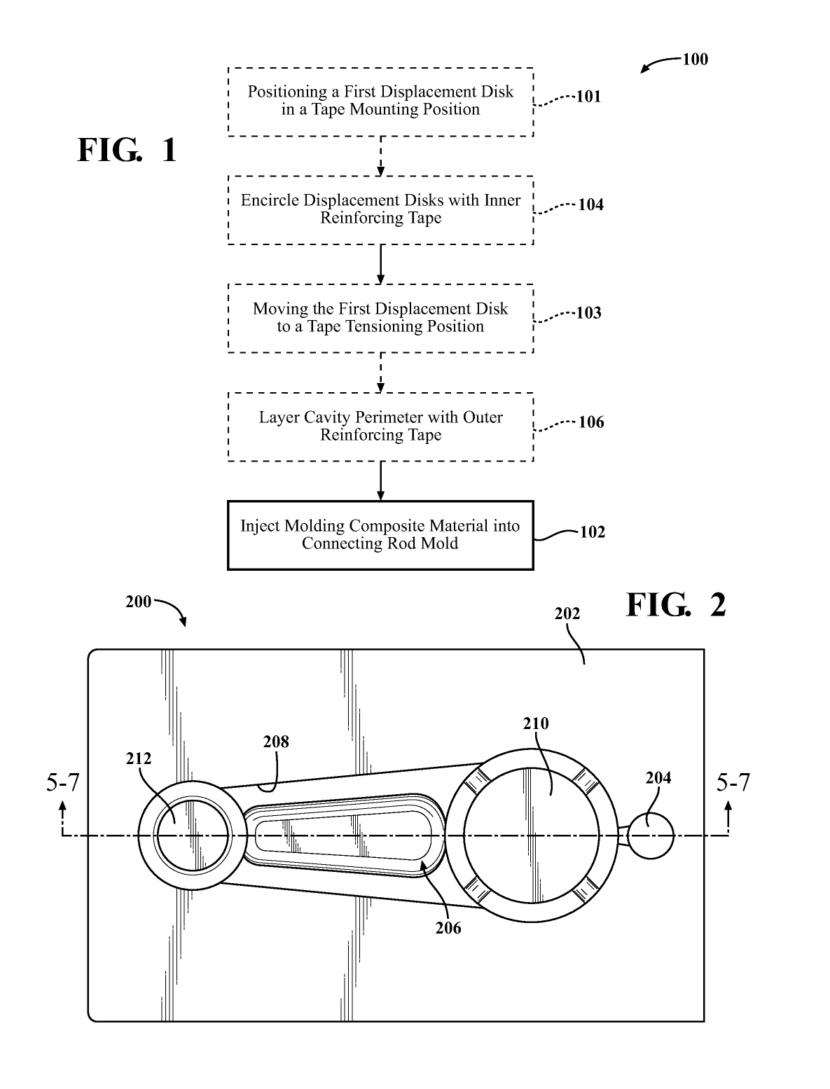

FIG. 1 describes a method 100 for fabricating a connecting rod, with optional steps contained within dashed lines. Method 100 includes a step 102 of injecting a composite material into a connecting rod mold. The composite material used in the injecting step will be referred to hereinafter as “molding-composite material”, and can include an organic polymer and reinforcing fiber. The organic polymer will typically be a thermoplastic or thermosetting polymer and can be of any suitable type, including but not limited to, polyetheretherketone (PEEK), polyether sulfone (PES), polyethylenimine (PEI), polyamide-imide (PAI), and polyphenylenesulfide (PPS). In some particular variations, the organic polymer contributing to the molding-composite material will be PEEK. In other variations, the organic polymer comprised by the molding-composite material will be PES.

It is to be noted that the injecting step referenced above, describing an injection molding process, could be replaced with an alternative molding process, such as compression molding. As such, step 102 can be described as a “molding” step rather than an “injecting” step. It has been found, however, that an injection molding process tends to confer an enhanced tensile strength. Without being bound to any particular theory, this is believed to be due to a more effective alignment of reinforcing fibers resulting from the injection process.

In some instances, the molding-composite material will be more than 10% reinforcing fiber by weight and the remainder will include organic polymer. In some instances, the molding-composite material will be 20-50% reinforcing fiber by weight and the remainder will include organic polymer. In some instances, the molding-composite material will be 30-40% reinforcing fiber by weight and the remainder will include organic polymer. In some instances, the molding-composite material will be 30-40% reinforcing fiber by weight and the remainder will be organic polymer. In some instances, the lengths of reinforcing fibers included in the molding-composite material will range predominantly from about 0.1 mm to about 12 mm.

An example of a suitable connecting rod mold 200 is illustrated in FIG. 2. The connecting rod mold 200 may include a face 202, and injection port 204, and a recessed cavity 206. The recessed cavity 206 represents the space occupied by the molding-composite material after injection. For purposes of clarity, the connecting rod mold 200 is shown without a cover that attaches to face 202 to enclose the recessed cavity 206. The cover includes various contours for forming a side of the connecting rod. The connecting rod mold 200 further includes a cavity perimeter 208 for forming an outer circumference of the connecting rod. The interior cavity perimeter 208 will typically comprise a curved planar surface that can be orthogonal to the face 202. Disposed within the cavity 206 are a first displacement disk 210 and a second displacement disk 212, configured to exclude molding-composite material from volumes which will become apertures in the connecting rod. For example, the first displacement disk 210 forms an aperture in the connecting rod for receiving a crankshaft and the second displacement disk 212 forms and aperture for receiving a piston connecting pin.

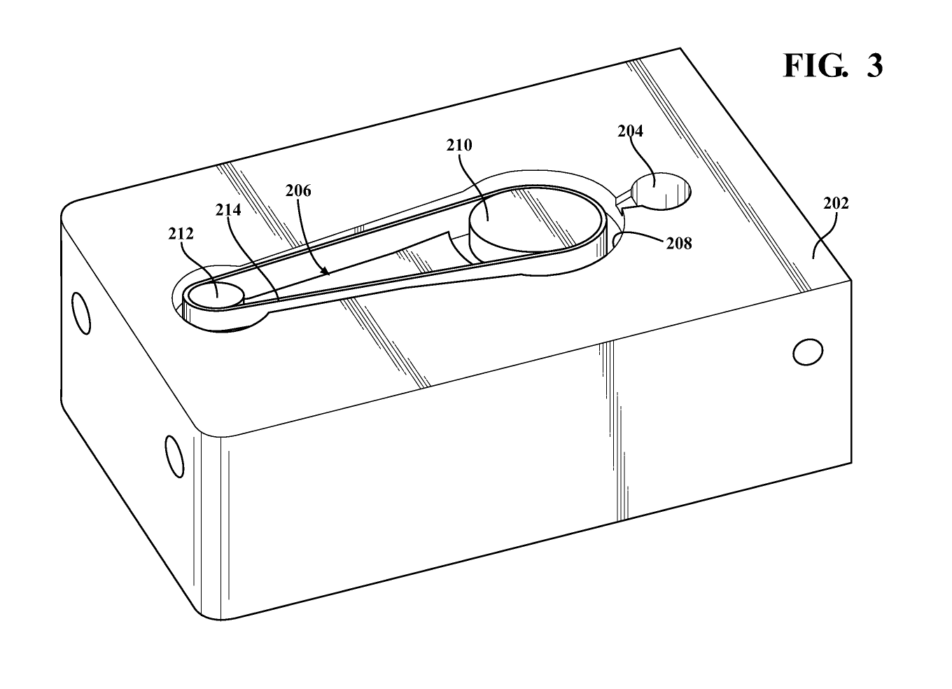

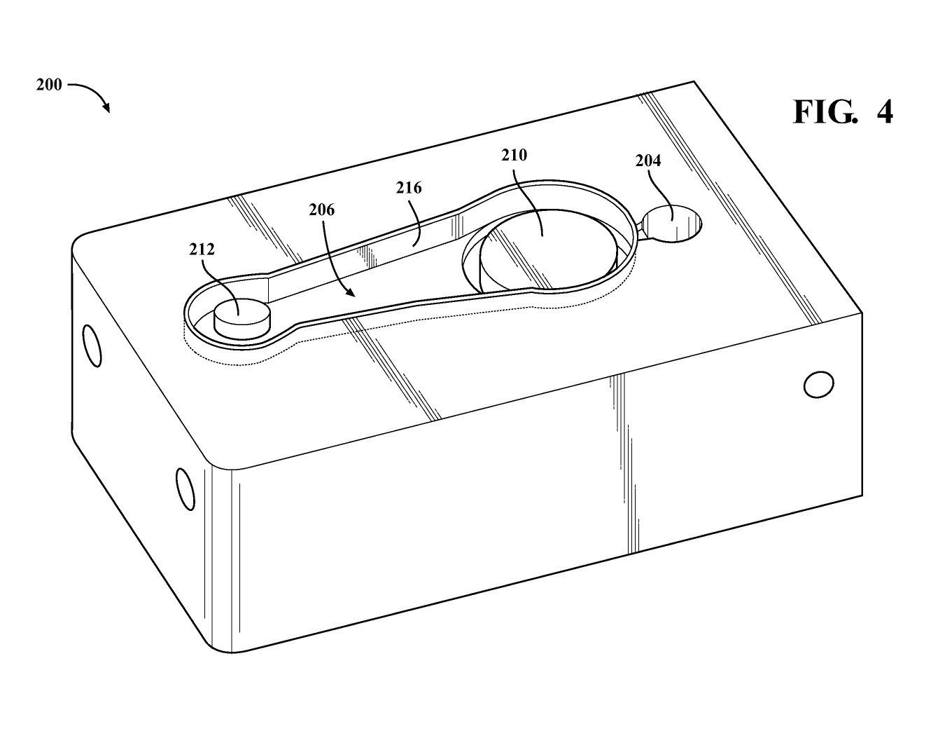

With reference also to FIGS. 3 and 4, some variations of the method 100 can include an additional step 104 of encircling the first and second displacement disks 210 and 212, respectively, with an inner reinforcing tape 214 and an outer reinforcing tape 216. When the encircling step 104 is employed, it may be desirable that the inner reinforcing tape 214 tightly encircle the displacement disks 210, 212, without substantial slack. The same or other variations of the method 100 can include an additional step 106 of layering at least a portion of the perimeter 208 of the connecting rod mold 200 with the outer reinforcing tape 216.

For clarity, the reinforcing tape 114 used in the encircling step 104 will be referred to hereinafter as an “inner reinforcing tape” and a reinforcing tape 116 used in the layering step 106 will be referred to hereinafter as an “outer reinforcing tape”. When either is or both are employed, the encircling and layering steps 104 and 106 will typically precede the injecting step 102. When both are employed, the encircling and layering steps 104 and 106 can be performed in any order relative to one another. For example, while FIG. 1 describes the encircling step 104 as preceding the layering step 106, the layering step 106 can alternately precede the encircling step 104.

With continued reference to FIGS. 3 and 4, the connecting rod mold 200 is shown subsequent to an encircling step 104 (see FIG. 3) and subsequent to a layering step 106 (see FIG. 4). In FIG. 3, the inner reinforcing tape 214 is shown tightly encircling the first and second displacement disks 210 and 212. In FIG. 4, the outer reinforcing tape 216 is shown layering the cavity perimeter 208 (see FIG. 1) of the connecting rod mold 200.

In many instances, an inner reinforcing tape 214, an outer reinforcing tape 216, or both may be configured as a cyclic tape. As used here, the term “cyclic tape” refers to a tape having no longitudinal ends, but instead forming a closed loop such, as a circumference or other cyclic structure. A cyclic tape can be formed, for example, by fixedly adjoining the longitudinal ends of a linear or otherwise longitudinally-ended tape. For increased strength of the cyclic tape, the cyclic tape can be directly fabricated as a closed loop rather than being fabricated as a linear or otherwise longitudinally-ended tape with subsequent joining of the longitudinal ends. A cyclic tape that is formed as such directly, rather than being formed by adjoining longitudinal ends, can be referred to as an “incipiently cyclic tape”.

When used, the reinforcing tape (for example, inner reinforcing tape 114 and outer reinforcing tape 116) can be composed of any suitable material, such as metal or organic polymer. In many instances, the reinforcing tape will be composed substantially of a composite material, which will be referred to hereinafter as “tape composite material”. Tape composite material can include reinforcing fiber and an organic polymer. In some instances, the tape composite material will include a unidirectional carbon fiber structure embedded in an organic polymeric matrix. The organic polymer will typically be a thermoplastic or thermosetting polymer and can be of any suitable type, including but not limited to, polyetheretherketone (PEEK), polyether sulfone (PES), polyethylenimine (PEI), polyamide-imide (PAI), and polyphenylenesulfide (PPS).

In some variations, the organic polymer comprised by the tape composite material will be selected so that it has a lower melting point than the melting point of the organic polymer comprising the molding-composite material. Such a selection can cause the tape composite material to be at least partly melted or softened by the heat contained in the injected molding-composite material, thereby improving adhesion or fusion of the reinforcing tape with the molding-composite material. In some particular variations, the organic polymer comprised by the tape composite material will be PPS.

In some instances, the tape composite material will be more than 10% reinforcing fiber by weight and the remainder will include organic polymer. In some instances, the tape composite material will be 20-50% reinforcing fiber by weight and the remainder will include organic polymer. In some instances, the tape composite material will be 30-40% reinforcing fiber by weight and the remainder will include organic polymer. In some instances, the tape composite material will be 30-40% reinforcing fiber by weight and the remainder will be organic polymer.

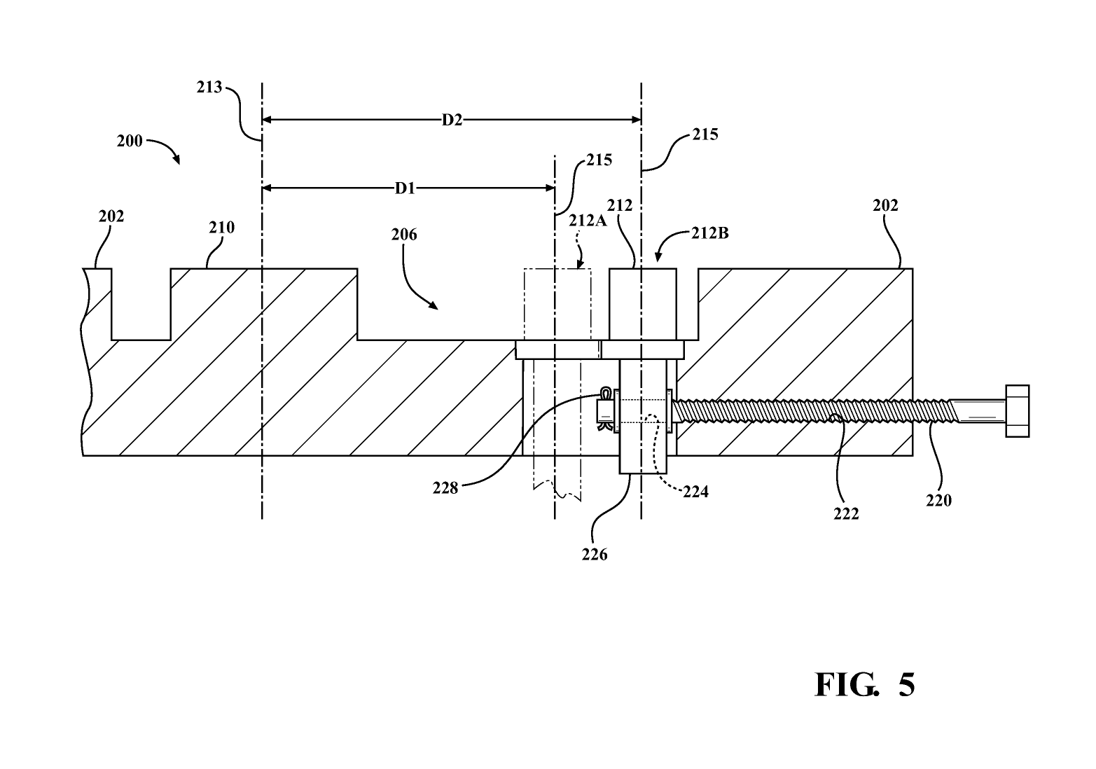

The first displacement disk 210 and the second displacement disk 212, or both displacement disks 210 and 212 of the connecting rod mold 200, may be configured to be selectively movable relative to one another to facilitate mounting of the inner reinforcing tape 114 on the first and second displacement disks 210 and 212. For example, with reference to FIG. 5, the second displacement disk 212 may be configured to be moveable relative to the first displacement disk 210 between a tape mounting position 212A and a tape tensioning position 212B. A first distance D1 between a center axis 213 of the first displacement disk 210 and a center axis 215 of the second displacement disk 212 when the second displacement disk 212 is arranged in the tape mounting position 212A is less than a second distance D2 when the second displacement disk 212 is arranged in the tape tightening position 212B. The second displacement disk 212 may be infinitely moveable between the tape mounting position 212A and the tape tightening position 212B. The first displacement disk 210 may be similarly configured to be moveable relative to the second displacement disk 212.

With continued reference to FIG. 5, to facilitate positioning of the second displacement disk 212, a threaded rod 220 may be threadably attached to the second displacement disk 212. The threaded rod 220 being movable (rotatably and reversibly engageable) with a complementarily threaded aperture 222 appropriately positioned in the connecting rod mold 200. The threaded rod 220 may rotatably engage an aperture 224 formed in a shank 226 of the second displacement disk 212. A locking pin 228, or another suitable fastener, may be used for securing the threaded rod 220 to the second displacement disk 212. The position of the second displacement disk 212 may be adjusted by rotating the threaded rod 220 to move the second displacement disk between the tape mounting position 212A and the tape tensioning position 212B. The first displacement disk 210 may also employ a similar mechanism for adjusting a position of the first displacement disk 210 relative to the second displacement disk 212.

Movability of either or both displacement disks 210 and 212 can facilitate deployment of the inner reinforcing tape 214 that encircles the displacement disks 210 and 212 tightly. For example, the inner reinforcing tape 214 may be positioned in the mold 200 by first moving the second displacement disk 212 to the tape mounting position 212A (see, for example, step 101 of FIG. 1) that allows for relatively easy mounting of the inner reinforcing tape 214 to the first displacement disk 210 and the second displacement disk 212. Slack in the inner reinforcing tape 214 may be substantially eliminated by rotating the threaded rod 220 to move the second displacement disk 212 from the tape mounting position 212A to the tape tensioning position 212B (see, for example, step 103 of FIG. 1), thereby increasing the distance between the two first and second displacement disks 210 and 212.

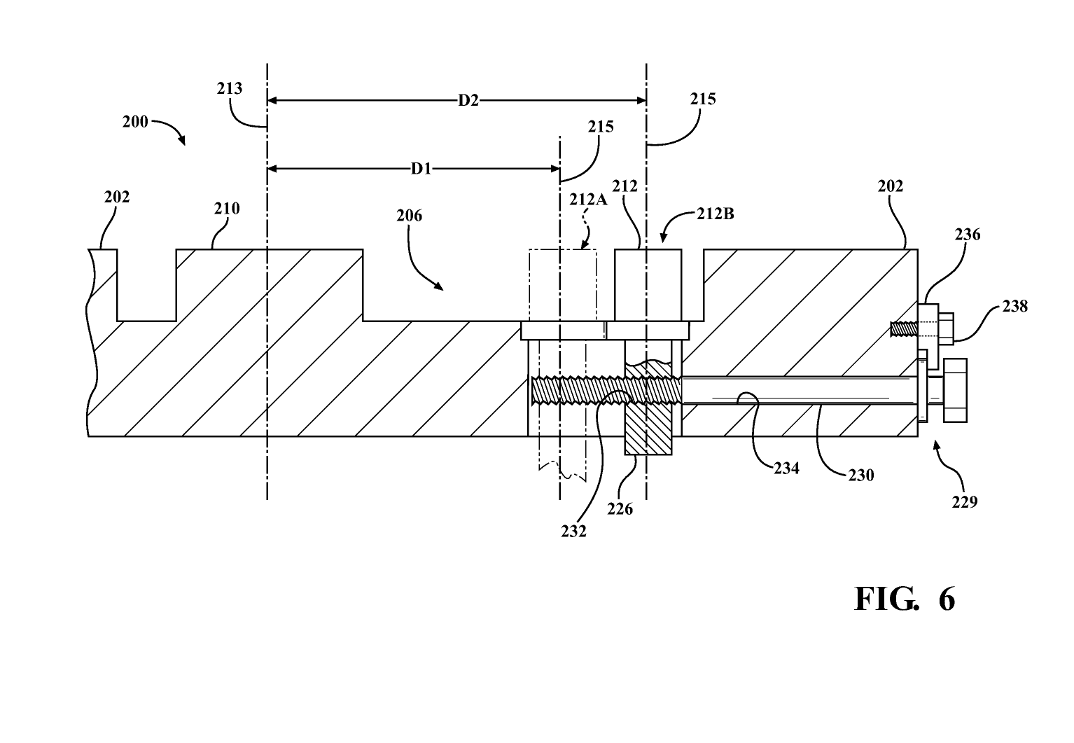

FIG. 6 illustrates an alternately configured adjusting mechanism 229 for controlling a position of the second displacement disk 212 relative to the first displacement disk 210. The adjusting mechanism 229 may include a threaded rod 230 that threadably engages a threaded aperture 232 formed in the shank 226 of the second displacement disk 212. The threaded rod 230 rotatable engages an aperture 234 formed in the mold 200. A locking tab 236 may be used to secure the threaded rod 230 to the mold 200. A bolt 238, or another fastener, may be used to secure the lacking tab 236 to the mold 200. The position of the second displacement disk 212 relative to the first displacement disk 210 may be adjusted by rotating the threaded rod 230 to move the second displacement disk 212 between the tape mounting position 212A and the tape tensioning position 212B. The first displacement disk 210 may also employ a similar mechanism for adjusting a position of the first displacement disk 210 relative to the second displacement disk 212.

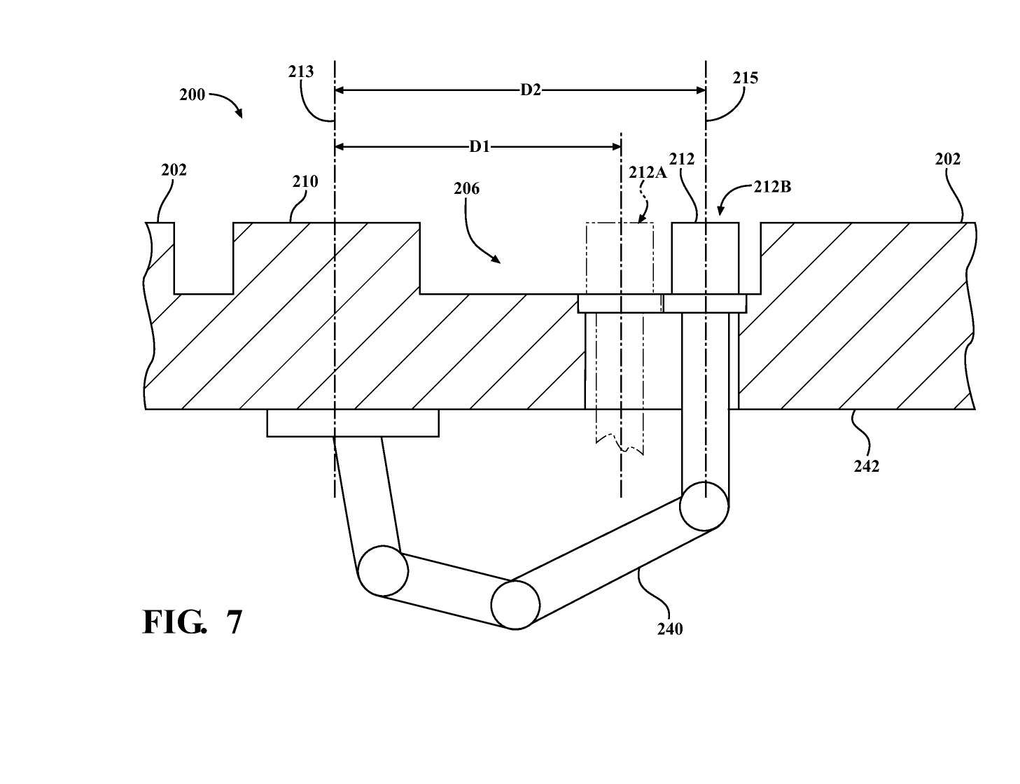

With reference to FIG. 7, in yet another alternative example of a movable displacement disk 210 or 212, the displacement disk 210 or 212 can be slideably movable within mold 200. FIG. 7 shows a longitudinal, side cross-sectional view of the connecting rod mold 200 of the type shown in FIG. 2. In the example of FIG. 7, the second displacement disk 212 is slideably repositionable between the tape mounting position 212A and the tape tensioning position 212B. When in the tape mounting position 212A, the distance D1 between the first and second displacement disks 210, 212 is smaller than the distance D2 when the second displacement disk 212 is positioned in the tape tensioning position 212B, thereby facilitating loose encircling of the two displacement disks 210, 212 with the inner reinforcing tape 214. Subsequent movement of the second displacement disk 212 to the tape tensioning position 212B causes tight encirclement of the two displacement disks 210, 212 by the inner reinforcing tape 214. Also in the example of FIG. 7, movement of the second displacement disk 212 may be facilitated by a tri-hinged exocentric arm 240, accessible from a back side 242 of the mold 200. As will be obvious to one skilled in the art, other means of achieving movability of the first displacement disk 210, the second displacement disk 212, or both are possible.

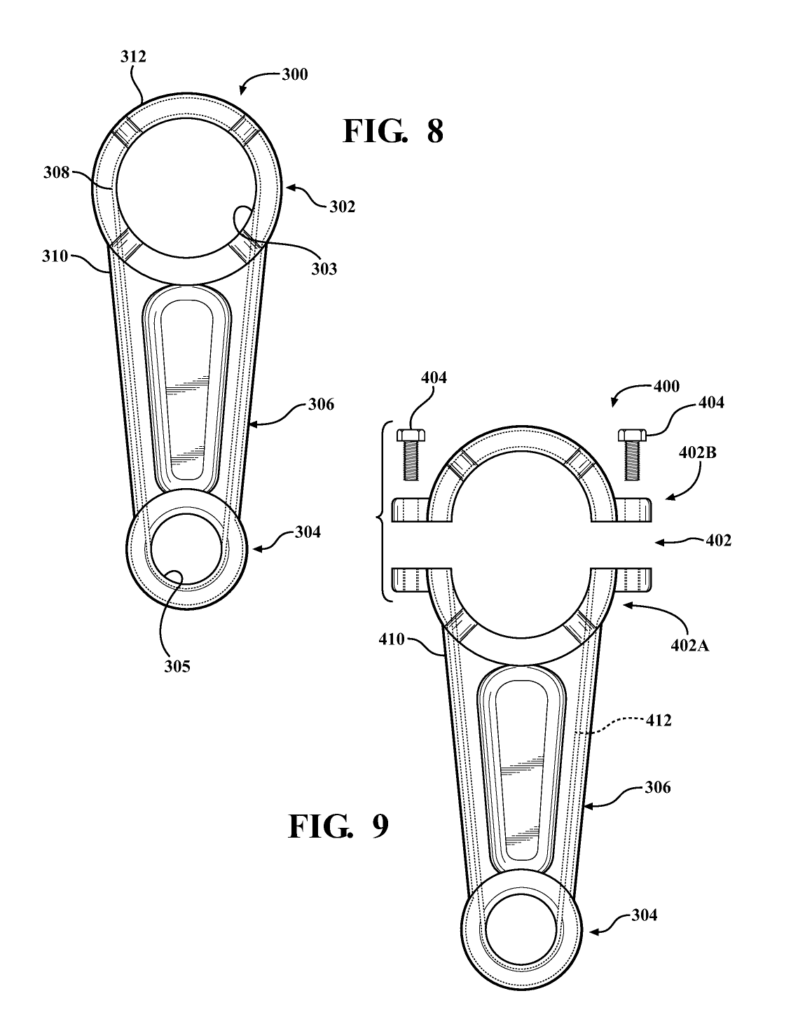

With reference to FIG. 8, disclosed is a connecting rod 300 composed substantially of a moldable composite material. The moldable composite material includes reinforcing fiber in admixture with a thermoplastic or thermosetting organic polymer. As above, the term “reinforcing fiber” as used herein can refer to any or a combination of carbon fiber, aramid fiber, or carbon nanotubes. The connecting rod 300 is operable to connect and transfer motion from a piston pin to a crankshaft in an internal combustion engine.

With continued reference to FIG. 8, an example of a connecting rod 300 includes a shaft engagement element 302 defining an aperture 305 operable to engage a vehicle crankshaft, and a piston engagement element 304 defining and aperture 305 operable to engage a vehicle piston pin. The connecting rod 300 additionally includes a connecting arm 306, traversing the distance between the shaft engagement element 302 and the piston engagement element 304.

The organic polymer comprised by the moldable composite material will typically be a thermoplastic or thermosetting polymer and can be of any suitable type, including but not limited to, polyetheretherketone (PEEK), polyether sulfone (PES), polyethylenimine (PEI), polyamide-imide (PAI), and polyphenylenesulfide (PPS). In some particular variations, the organic polymer comprised by the moldable composite material will be PEEK. In some particular variations, the organic polymer comprised by the moldable composite material will be PES.

In some instances, the moldable composite material will be more than 10% reinforcing fiber by weight and the remainder will include organic polymer. In some instances, the moldable composite material will be 20-50% reinforcing fiber by weight and the remainder will include organic polymer. In some instances, the moldable composite material will be 30-40% reinforcing fiber by weight and the remainder will include organic polymer. In some instances, the moldable composite material will be 30-40% reinforcing fiber by weight and the remainder will be organic polymer.

The connecting rod 300 can optionally include an inner reinforcing tape 308. When used, the inner reinforcing tape 308 simultaneously encircles at least a portion of the inner circumference of the shaft engagement element 302 and at least a portion of the inner circumference of the piston engagement element 304 of the connecting rod 300. When used, the inner reinforcing tape 308 is incorporated into the connecting rod 300 and is at least partially surrounded by the moldable composite material. The inner reinforcing tape 308 at least partially defines the aperture 303 in the shaft engagement element 302 for receiving the crankshaft and the aperture 305 in the piston engagement element 304 for receiving the piston pin.

The connecting rod 300 can also optionally include an outer reinforcing tape 310. When used, the outer reinforcing tape 310 permanently contacts outer edges 312 of the moldable composite material of connecting rod 300 and encircles the periphery of connecting rod 300. Permanence of contact between outer edges 312 of the moldable composite material and the outer reinforcing tape 310 can be achieved by the moldable composite material having been cured in contact with or in partial surrounding of the outer reinforcing tape 310. Permanence of contact can also be achieved by the outer reinforcing tape 310 having a melting temperature sufficiently low that it is partially heat softened during curing of the moldable composite material.

For brevity, the phrase “a reinforcing tape” will be used hereinafter to refer generically to either the inner reinforcing tape 308 or the outer reinforcing tape 310, or to refer to the inner reinforcing tape 308 and the outer reinforcing tape 310 as a group. As such, a reinforcing tape can be composed of any suitable material, such as metal or organic polymer. In many instances, a reinforcing tape will be composed substantially of a composite material which will be referred to hereinafter as “reinforcement composite material”. Reinforcement composite material can include reinforcing fiber and an organic polymer. In some instances, the tape composite material will include a unidirectional reinforcing fiber structure in an organic polymeric matrix.

The organic polymer will typically be a thermoplastic or thermosetting polymer and can be of any suitable type, including but not limited to, polyetheretherketone (PEEK), polyether sulfone (PES), polyethylenimine (PEI), polyamide-imide (PAI), and polyphenylenesulfide (PPS). In some variations, the organic polymer comprised by the reinforcement composite material will be selected so that it has a lower melting point than that of the organic polymer comprising the moldable composite material. In some particular variations, the organic polymer comprised by the reinforcement composite material will be PPS.

In some instances, the reinforcement composite material will be more than 10% reinforcing fiber by weight and the remainder will include organic polymer. In some instances, the reinforcement composite material will be 20-50% reinforcing fiber by weight and the remainder will include organic polymer. In some instances, the reinforcement composite material will be 30-40% reinforcing fiber by weight and the remainder will include organic polymer. In some instances, the reinforcement composite material will be 30-40% reinforcing fiber by weight and the remainder will be organic polymer.

While the shaft engagement element 302 and the piston engagement element 304 are each shown as a ring, or circular structure in FIG. 8, a ring structure is not specifically required. For example, the shaft engagement element 302 could be an open-ended harness. An alternative example a connecting rod is shown in FIG. 9 as a two-piece connecting rod 400. In the two-piece connecting rod 400 of FIG. 9, a shaft engagement element 402 includes an open harness 402A for easy engagement with a crankshaft. The shaft engagement element 402 also includes an optional capping member 402B that can be secured to the open harness 402A after engagement with the crankshaft, for example, using fasteners 404. The two-piece connecting rod 400 of FIG. 9 may include an outer reinforcement tape 410 that is not cyclic and that is contained only within the larger piece of the two-piece structure. The example of FIG. 9 also illustrates a non-cyclic inner reinforcing tape 412. It may, in some instances, be preferable to exclude the non-cyclic inner reinforcing tape 412 from a two-piece design of this variety.

It should be noted that the method 100 for fabricating a connecting rod is applicable to the two-piece connecting rod 400, for example, of the type illustrated in FIG. 9. In such a situation, the optional step 104 of encircling the first and second displacement disks with a reinforcing tape can be modified to correspond with the configuration of the inner reinforcing tape 412 in FIG. 9. As such, in the method 100, as applied to fabrication of a two-piece connecting rod, the first displacement disk 210 is semicircular, corresponding to open harness 402A, while the second displacement disk 212 is circular. Step 104 of method 100 would then involve wrapping a reinforcing tape in a pseudo-parabolic shape from one side of the first displacement disk 210, which is semicircular, around the second displacement disk 212, and to the opposite side of the first displacement disk 210.

While the methods and connecting rods disclosed herein have been described as being particularly applicable to automotive vehicles and aeronautical vehicles, it should be appreciated that they are applicable to any engine, motor, or device in which a connecting rod is employed to transfer the reciprocating motion of a piston to the rotary motion of a connecting rod.

Various aspects of the present disclosure are further illustrated with respect to the following Examples. It is to be understood that these Examples are provided to illustrate specific configurations of the present disclosure and should not be construed as limiting the scope of the present disclosure in or to any particular aspect.

### Example 1

### Fabrication of Carbon Fiber/PEEK Connecting Rod

A connecting rod mold of the type shown in FIG. 2 is closed and hot injected with a composite material. The composite material consists of ˜30% carbon fiber ˜0.1-12 mm length, 70% PEEK. After curing, the composite connecting rod is removed from the mold. The resulting connecting rod is referred to below as a “no-tape” connecting rod.

Separately, the two pins or displacement disks in a connecting rod mold of the type shown in FIG. 2 are tightly encircled with a unidirectional cyclic tape of carbon fiber/PPS. The periphery of the connecting rod mold cavity space is layered with a unidirectional cyclic tape of carbon fiber/PPS. In both cases, carbon fiber content of the cyclic tape is about 40%, the remainder PPS, and the tape is cyclized by adhesively affixing the ends of a linear tape.

The mold is closed and hot injected with a composite material. The composite material consists of ˜30% carbon fiber ˜0.1-12 mm length, 70% PEEK. After curing, the composite connecting rod is removed from the mold. The resulting connecting rod is referred to below as a “2-tape” connecting rod.

### Example 2

### Tensile Strength Testing of Carbon Fiber/PEEK Connecting Rod

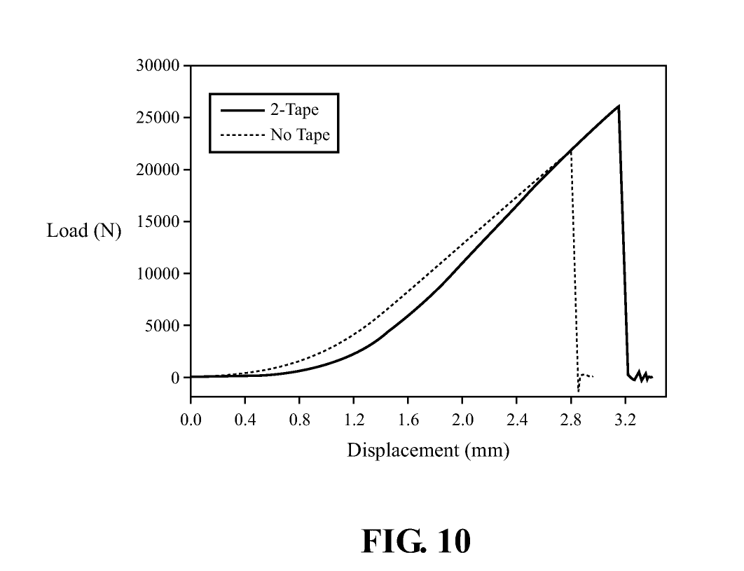

The no-tape and the 2-tape connecting rods, whose fabrication is described above in Example 1, were each subjected to a tensile strength test. In the test, the piston engagement element and the shaft engagement element of the connecting rod being tested were engaged to a force application/displacement measurement instrument. The instrument exerted a continuously increasing tensile force, i.e. the piston engagement element and shaft engagement element were loaded in opposite directions, and displacement, i.e. stretch or other deformation, of the connecting rod was measured. The results of the test are shown in FIG. 10. The results for the 2-tape connecting rod are depicted as a solid line, while the results for the no-tape connecting rod are depicted as a dotted line. In each case, the connecting rod progressively displaced with increasing force application until part failure. Part failure, i.e. physical fracture, is indicated by the precipitous decline in force after a continuous, gradual force increase, for each data trace. As shown, the no-tape connecting rod failed at an applied force of ˜21.5 kN, while the 2-tape connecting rod failed at an applied force of ˜26.1 kN. These results demonstrate the improvement in tensile strength conferred by the reinforcing tapes. The maximum force reached prior to failure is referred to as the tensile failure point.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A vehicle connecting rod comprising:
a shaft engagement element at least partially defining an aperture for receiving a crankshaft;
a piston engagement element at least partially defining an aperture for receiving a piston connecting pin;
a connecting arm connecting the shaft engagement element to the piston engagement element; and
a continuous band of reinforcing tape disposed within the shaft engagement element, the piston engagement element and the connecting arm, the reinforcing tape extending at least partially around the apertures defined by the shaft engagement element and the piston engagement element.

2. The connecting rod as recited in claim 1, wherein the reinforcing tape comprises carbon fiber and an organic polymer.

3. The connecting rod as recited in claim 2, wherein the shaft engagement element, the piston engagement element and the connecting arm include a molding-composite material including carbon fiber and an organic polymer, the organic polymer in the reinforcing tape having a lower melting point than the organic polymer in the molding-composite material.

4. The connecting rod as recited in claim 3, wherein the organic polymer in the reinforcing tape is any of PES, PEI, PAI, PPS, and PEEK.

5. The connecting rod as recited in claim 2, wherein the organic polymer in the reinforcing tape is a thermoplastic polymer.

6. The connecting rod as recited in claim 1, wherein the shaft engagement element, the piston engagement element and the connecting arm rod include carbon fiber and an organic polymer.

7. The connecting rod as recited in claim 6, wherein the organic polymer is a thermoplastic polymer.

8. The connecting rod as recited in claim 6, wherein the organic polymer is any of PES, PEI, PAI, PPS, and PEEK.

9. The connecting rod as recited in claim 1, wherein the reinforcing tape includes a width and thickness, the width being substantially greater than the thickness.

10. The connecting rod as recited in claim 9, wherein the reinforcing tape is oriented widthwise substantially parallel to a central axis of the aperture in the shaft engagement element and a central axis in the piston engagement element.

11. The connecting rod as recited in claim 1, wherein the reinforcing tape at least partially defines the apertures in the shaft engagement element and the piston engagement element.

12. The connecting rod as recited in claim 1, wherein the reinforcing tape at least partially defines an outer perimeter of the connecting rod.

13. The connecting rod as recited in claim 1, wherein the reinforcing tape is pulled taught between the shaft engagement element and the piston engagement element.

14. The connecting rod as recited in claim 1, wherein the reinforcing tape forms an uninterrupted continuous loop.

15. The connecting rod as recited in claim 1, where the reinforcing tape comprises unidirectional carbon fiber in an organic polymeric matrix.

16. A method for fabricating a connecting rod, the method comprising:
positioning a band of reinforcing tape within a connecting rod mold having a first displacement disk and a second displacement disk, the reinforcing tape including carbon fiber and an organic polymer, the reinforcing tape extending at least partially around the first and second displacement disks; and
molding a composite material into the connecting rod mold, the composite material comprising carbon fiber and an organic polymer.

17. The method as recited in claim 16, where first displacement disk forms an aperture in the connecting rod for receiving a crankshaft and the second displacement disk forms an aperture in the connecting rod for receiving a piston connecting pin, the method further comprising directly engaging the reinforcement tape with the first and second displacement disks.

18. The method as recited in claim 16, wherein the first displacement disk is selectively movable between a tape mounting position and a tape tensioning position, the method further comprising:
positioning the first displacement disk in the tape mounting position prior to positioning the reinforcing tape around the first and second displacement disks; and
tensioning the reinforcing tape by moving the first displacement disk from the tape mounting position to the tape tensioning position.

19. The method as recited in claim 16, wherein the organic polymer is a thermoplastic polymer.

20. The method as recited in claim 19, wherein the organic polymer is any of PES, PEI, PAI, PPS, and PEEK.

21. The method as recited in claim 16, wherein the reinforcing tape forms an uninterrupted continuous loop.

22. The method as recited in claim 16 further comprising layering the reinforcing tape along an interior surface of the connecting rod mold for forming an outer circumference of the connecting rod prior to molding the composite material into the connecting rod mold.

23. A mold for fabricating a connecting rod, the mold comprising:
a recessed cavity for forming an outer contour of the connecting rod;
a first displacement disk disposed within the recessed cavity, the first displacement disk forming an aperture in the connecting rod for receiving a crankshaft; and
a second displacement disk disposed within the recessed cavity, the second displacement disk forming an aperture in the connecting rod for receiving a piston connecting pin, wherein the first displacement disk is selectively movable relative to the second displacement disk between a tape mounting position and a tape tensioning position.

24. The mold as recited in claim 23, wherein a distance between a center axis of the first displacement disk and a center axis of the second displacement disk when the first disk is disposed in the tape tensioning position is greater than a distance between the center axis of the first displacement disk and the center axis of the second displacement disk when the first disk is disposed in the tape mounting position.

25. The mold as recited in claim 23, wherein the second displacement disk is selectively movable relative to the first displacement disk between a tape mounting position and a tape tensioning position.
